(19) United States
(12) Patent Application Publication
(10) Pub. No.: US 2009/0148229 A1
(43) Pub. Date: Jun. 11, 2009

(54) Sealing and securing element for homokinetic joints of longitudinal shafts

(75) Inventors: Gerald Langer, Bulstringen (DE); Sebastian Frost, Bindfelde (DE)

Correspondence Address: COLLARD & ROE, P.C., 1077 NORTHERN BOULEVARD, ROSLYN, NY, 11576, US

(73) Assignee: IFA-Technologies GmbH

(21) Appl. No.: 12/316,005

(22) Filed: Dec. 9, 2008

(30) Foreign Application Priority Data
Dec. 10, 2007 (DE) 10 2007 059 629.6
Mar. 28, 2008 (DE) 10 2008 016 129.2

(51) Int. Cl. F16D 1/072

(52) U.S. Cl. 403/282

(57) ABSTRACT

A sealing and securing element for a homokinetic joint between hollow longitudinal shafts is disposed in an interior of the longitudinal shaft in a region of a connection point of the longitudinal shaft to the homokinetic joint. The sealing and securing element includes a molded part and a closure lid. The molded part has an inner structure configured in a first stepped shape with two accommodation openings, a guide bevel in a direction of the homokinetic joint and a circumferential projection. The closure lid has an outer structure configured in a second stepped shape with two projections. The inner structure of the molded part is adapted to the outer structure of said closure lid and has a same coverage as the outer structure. The closure lid is pressed into an interior of the molded part and rests against the circumferential projection.

### CROSS REFERENCE TO RELATED APPLICATIONS

Applicants claim priority under 35 U.S.C. 119 of German Application No. 10 2007 059 629.6 filed Dec. 10, 2007 and German Application No. 10 2008 016 129.2 filed Mar. 28, 2008.

### BACKGROUND OF THE INVENTION

1. Field of the Invention

The invention relates to a sealing and securing element for homokinetic joints of longitudinal shafts for motor vehicles, wherein the longitudinal shafts are configured as hollow shafts, and wherein the homokinetic joint, in each instance, is sealed relative to the longitudinal shaft by way of a closure lid.

2. The Prior Art

Homokinetic joints of longitudinal shafts are components that are frequently used in motor vehicles, where the transfer of a rotational movement at a constant speed of rotation is desired or is supposed to be achieved. Some usual types of homokinetic joints are tripod displacement joints, axially fixed tripod joints, ball displacement joints, and axially fixed ball joints. The homokinetic joints are generally permanently lubricated with a lubricant grease, and sealed by means of a cuff when using drive shafts. This means that homokinetic joints are sealed in order to hold the lubricant grease within the joint, and to keep contaminants and foreign substances, e.g. dirt and water, outside of the joint.

In order to guarantee this protection, the homokinetic joints are usually closed off, on the open side of the outer joint part, by a sealing cuff made of rubber, a thermoplastic plastic, or silicone.

The opposite sides of the outer joint part are generally closed off by a hood, cap, or a closure lid.

In the arrangement of longitudinal drive shafts that are configured with homokinetic joints, not only the requirements regarding normal operation, for example sealing of the homokinetic joints, must be taken into consideration; also the behavior of the shaft arrangement in the case of a crash, i.e. particularly in the case of a frontal impact accident of the motor vehicle, must be considered.

In this connection, two significant requirements must be fulfilled.

For one thing, axial shortening of the shaft must be possible, in order to reliably prevent buckling and penetration into the passenger cell. Additionally, it is desirable that the shaft absorbs deformation energy, in noteworthy manner, while it is being shortened.

A longitudinal drive shaft for motor vehicles according to DE 43 44 177 C 1 is configured with an intermediate joint that is structured as an axially displaceable ball joint, and consists of at least one outer joint part and one inner joint part. The outer joint part is connected with a tubular shaft, in fixed manner, and the inner joint part is connected with a shaft journal.

Sealing of the joint takes place, on the one hand, by way of a rolling bellows arrangement, and, on the other hand, by means of a sheet-metal lid pressed into the outer joint part.

The dimensions and/or dimensioning of the components of the joints that are used are coordinated with one another in such a way that in the case of a crash, the telescoping parts can be displaced into one another.

The problem of sealing a homokinetic joint relative to a longitudinal shaft is solved, according to DE 102 05 538 A 1 by providing two closure lids in the outer joint part and ahead of the shaft.

DE 27 40 226 A 1 also relates to the problem of sealing a homokinetic joint. In particular, this reference seeks to create a cost-advantageous and efficient connection with a tubular shaft, in the case of a homokinetic joint, in which a functionally reliable seal between the joint and the tubular shaft is supposed to be given at the same time.

This is accomplished, according to DE 27 40 226 A1, by means of a closure cap having an integrated molded part that is fixed in place in the hollow shaft in a single work step, and thus functions as a seal.

A similar manner of sealing a hollow shaft relative to a homokinetic rotary joint is described in DE 196 52 100 C1, wherein a sheet-metal lid is configured with a sealing element/molded part and finds accommodation in the hollow shaft, and thus seals the homokinetic rotary joint.

DE 10 2005 003 388 A 1 shows another solution for sealing a homokinetic joint, wherein one side of the joint is sealed by means of a cuff cover. The cuff cover is connected with one end of the outer joint part, and is further connected, by way of a crimp, with a cuff component that is connected with the drive shaft.

On the opposite side of the homokinetic joint, its interior is closed off by means of a closure lid. This closure lid consists of a metal material, which finds accommodation in the outer joint part of the homokinetic joint, and is attached to the outer ring collar of the homokinetic joint by means of a screw connection.

The solutions described above are suitable for implementing sealing of homokinetic joints, and are also partially suitable for having parts of the homokinetic joint be destroyed in the case of a crash, making them able to telescope within the longitudinal shaft.

A disadvantage of the solutions described above, however, is that great technical and financial efforts are required for their implementation and/or execution. Another disadvantage of the solutions described above is that the telescoping parts are displaced within one another without guidance in the case of a crash.

### SUMMARY OF THE INVENTION

The invention is therefore based on the task of further developing a sealing and securing element for homokinetic joints for longitudinal shafts, in such a manner that not only sealing of homokinetic joints towards the interior of the longitudinal shaft is guaranteed, but, at the same time, it is also assured that in the case of a crash, the destroyed functional elements can telescope, relative to one another, in guided manner.

This task is accomplished, according to an embodiment of the invention, by providing a sealing and securing element for a homokinetic joint between hollow longitudinal shafts. The sealing and securing element is disposed in an interior of the hollow longitudinal shaft in a region of a connection point of the hollow longitudinal shaft to the homokinetic joint. The sealing and securing element includes a molded part and a closure lid.

The molded part has an inner structure configured in a first stepped shape and having two accommodation openings. The molded part further includes a guide bevel in a direction of the homokinetic joint and a circumferential projection.

The closure lid is for sealing an interior of the homokinetic joint relative to the hollow longitudinal shaft. The closure lid includes an outer structure configured in a second stepped shape and having two projections.

The inner structure of the molded part is adapted to the outer structure of the closure lid and has a same coverage as the outer structure of the closure lid. The closure lid is pressed into an interior of the molded part and rests against the molded part's circumferential projection.

Further embodiments and particularly advantageous solutions are described as well.

A sealing and securing element according to an embodiment of the invention is a combination element that includes an elastic and deformable outer molded part and a closure lid integrated into the molded part.

The combination of the sealing and securing element is established by means of the configuration of the sealing and securing element and its arrangement in various transition regions of the outer joint of a homokinetic joint relative to a connected longitudinal shaft.

Thus, the molded part of the sealing and securing element may comprise a deformable material, for example an elastomer, which is deformable to a certain degree and is adaptable to the conditions when it is used for sealing a homokinetic joint of longitudinal shafts, on the basis of its elastic deformability, since the connection point transition regions from a homokinetic joint to a longitudinal shaft to be connected are not always the same in coverage, in terms of their outer shape. For example, these transition regions from the homokinetic joint to the longitudinal shaft, in each instance, are configured in cylindrical shape, and possess equally great outer dimensions. In addition, the longitudinal shaft can have a turned-over shape in its connection region to the homokinetic joint, which in turn means that the connection points of longitudinal shaft to homokinetic joint are the same in their geometrical dimensions, but the longitudinal shaft makes a transition into a shaft region having a smaller outside and inside diameter as compared with the homokinetic joint and the connecting piece of the hollow shaft. The use of the inventive sealing and securing element takes place, in this case of operation, in such a manner that the sealing and securing element is disposed directly in the center part/transition region between the smaller diameter and the greater diameter of the hollow shaft.

As a result of the deformability of the molded part of the sealing and securing element, the molded part adapts to the inner structure of the transition region of the longitudinal shaft.

Since it is known that limits are set, even for an elastomer material, with regard to its deformability, according to a preferred embodiment, the molded part of the sealing and securing element can be adapted, in its outer configuration and its dimensions, to the conditions of the transition region, in each instance.

The closure lid inserted/pressed into the molded part of the sealing and securing element may comprise a metallic material. The closure lid may be configured as a sheet-metal lid. Other materials can be used as well.

According to an embodiment of the present invention, the closure lid is pressed into the molded part of the sealing and securing element, in such a manner that the closed lid bottom of the closure lid points in the direction of the homokinetic joint and on the opposite side, the open side of the closure lid rests against a radially oriented and circumferential projection, a so-called nose, of the molded part with its outermost outer collar, and is thus positioned in the axial direction relative to the hollow shaft.

The closure lid is integrated into the interior of the molded part in pressed-in form, so that a force-fit connection between the closure lid and the molded part exists. A shape-fit connection between these two parts is provided by their shape configuration, by means of pressing of the closure lid into the molded part, since the inner region of the molded part adapts to the outer part of the closure lid, and furthermore by means of the radially oriented projection of the molded part.

The inventive sealing and securing element fulfills both its sealing function for sealing the homokinetic joint relative to the connected hollow shaft, and its securing function, in the case of a crash. This occurs in view of the fact that in the case of a crash, the functional parts that transfer torque, those of the longitudinal shaft and of the homokinetic joint, are supposed to telescope relative to one another, in order to prevent greater destruction of the motor vehicle and in particular, to prevent injuries to the person situated in the motor vehicle. Thus, the closure lid is disposed in and pressed into the molded part in such a manner that the sealing and securing element used also acts as a planned breaking point, if destruction of the homokinetic joint and of the longitudinal shaft occurs.

In this case, if the closure lid is pressed out of the molded part, the molded part serves as a guiding/securing element for the telescoping parts of the homokinetic joint during telescoping.

Accordingly, in a further embodiment of the invention, the molded part is configured to have a guide bevel that is directed inwards, in the direction of the homokinetic joint. This bevel acts as a guide for the elements that telescope into the interior of the hollow shaft, and additionally, the molded part is also displaced in the interior of the hollow shaft, in the axial direction, and even during this change in position it acts on the telescoping functional parts, to guide and secure them.

### BRIEF DESCRIPTION OF THE DRAWINGS

Other objects and features of the present invention will become apparent from the following detailed description considered in connection with the accompany drawings. It is to be understood, however, that the drawings are designed as an illustration only and not as a definition of the limits of the invention.

In the drawings, wherein similar reference characters denote similar elements throughout the several views:

FIG. 1: shows a configuration and arrangement of a sealing and securing element in the connection region of a longitudinal shaft towards the outer part of a homokinetic joint; and

FIG. 2: shows a configuration and arrangement of a sealing and securing element in the connection region of a cylindrically configured longitudinal shaft-towards the outer joint part of a homokinetic joint.

### DETAILED DESCRIPTION OF THE DRAWINGS

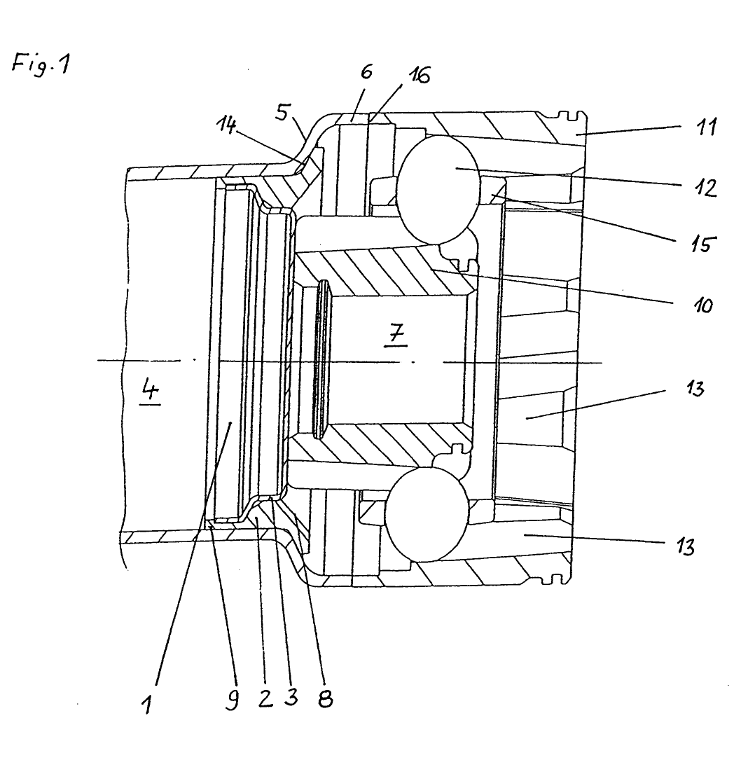

Referring now in detail to the drawings, the homokinetic joint 7 shown in FIG. 1 consists of the outer joint part 11 and the inner joint part 10, which are configured with running grooves 13, in which the roller bodies 12 are guided and surrounded by a cage 15. A transfer of torque from a drive shaft provided in the inner joint part 10 to the outer joint part 11 and from there to the longitudinal shaft 4, which is connected by way of a weld 16, takes place by way of the roller bodies 12 provided in the running grooves 13.

Sealing of the homokinetic joint 7 takes place in the direction of the drive shaft, thus on the right side of the homokinetic joint 7, by means of a folded bellows, which is connected to the outer joint part 11 and to the drive shaft. For reasons of the overview, the drive shaft is not shown here; sealing in this region corresponds to that of known solutions.

On the left side, the homokinetic joint is sealed by means of the sealing and securing element 1, so that the lubricant grease present in the interior of the homokinetic joint 7 cannot exit, even if the lubricant grease is heated due to operation of the homokinetic joint 7 and thus becomes more liquid.

Also, the arrangement of the sealing and securing element 1 guarantees that undesirable foreign substances that would impair the functional reliability of the homokinetic joint 7 cannot get into the interior of the homokinetic joint.

The configuration and the placement of the sealing and securing element 1 are also shown in FIG. 1, from which it is evident that the sealing and securing element 1 includes a molded part 2 and a closure lid 3 inserted into the molded part 2, and the sealing and securing element 1 including the molded part 2 and the closure lid 3 is integrated into the longitudinal shaft 4.

The molded part 2 may include a material that is elastic, soft, and deformable, to the greatest possible extent, for example, an elastomer. Alternative materials can also be used for the production of the molded part 2, which materials are produced from an easily deformable metal material or another material, which materials possess the approximate properties of an elastomer.

The formation, in terms of material, of the molded part 2 from an elastomer is advantageous in that while observing the tolerances of the inside dimensions of the longitudinal shaft 4 and the outside dimensions of the molded part 2, as well as the shaping of these two parts, it is guaranteed, in this region, that the molded part 2 with the closure lid 3 can be pressed into the longitudinal shaft 4, that a pressed connection forms in this region, between the longitudinal shaft 4 and the molded part 2, to the greatest possible extent, and that this connection is additionally secured by means of the outer circumferential collar 14 of the molded part 2, which rests against the center part 5 of the longitudinal shaft 4 in the pressed-in state of the molded part 2.

The closure lid 3 is configured in a stepped shape, and, as shown in FIG. 1, may possess two outer diameters. The closure lid 3 is configured to be closed in the direction of the homokinetic joint 7, and open towards the interior of the longitudinal shaft 4. The inner configuration of the molded part 2 corresponds to the outer shape of the closure lid 3, so that the closure lid 3 is connected with the molded part 2 both with shape fit and with force fit. The force-fit connection between these two parts is achieved in that the inner dimensions of the molded part 2 are smaller, in terms of diameter, as compared with the outside diameters of the closure lid 3, and pressing-in of the closure lid 3 is guaranteed by means of the configuration of the molded part 2, in terms of material. The inserted closure lid 3 is additionally locked in place by means of a circumferential projection 9 of the molded part 2.

The molded part 2 may be configured with a guide bevel 8 in the direction of the homokinetic joint 7, as is also shown in FIG. 1. The bevel runs all the way to the inserted closure lid 3.

The connection between the homokinetic joint 7 and the longitudinal shaft 4 takes place in the cylindrically configured outer left region of the outer joint part 11, to the connecting piece 6 of the longitudinal shaft 4, which is also configured cylindrically, by means of a weld 16.

The position of the inner joint part 10, as shown, for example in FIG. 1, makes it clear that the inner joint part 10 rests against the outer right face surface of the closure lid 3, and in the case of a further axial force effect on the inner joint part 7, the latter would be displaced further in the direction of the longitudinal shaft 4. In this case, the securing function of the sealing and securing element 1 becomes active, since in the case of further forward movement of the inner joint part 10, the closure lid 3 is pressed out of its position within the molded part 2 and displaced into the interior of the longitudinal shaft 4. As a result of the closure lid 3 being pressed/pushed out of the molded part 2, this molded part 2 takes over the guidance of the telescoping parts, so that these can get into the interior of the longitudinal shaft 4 without buckling sideways. This relates to both the inner joint part 10 and to the roller bodies 12 that exit from the running grooves 13.

In this connection, it is advantageous that the homokinetic joint 7 breaks down into its individual parts almost without force, and the sealing and securing element 1, which specifically also functions as a planned breaking point, lies outside of the homokinetic joint 7, so that aside from the destruction of the sealing and securing element 1, unhindered telescoping of the functional parts that are displaced in the case of a crash takes place, to the greatest possible extent, and this has a positive effect on the entire telescoping process, as a whole.

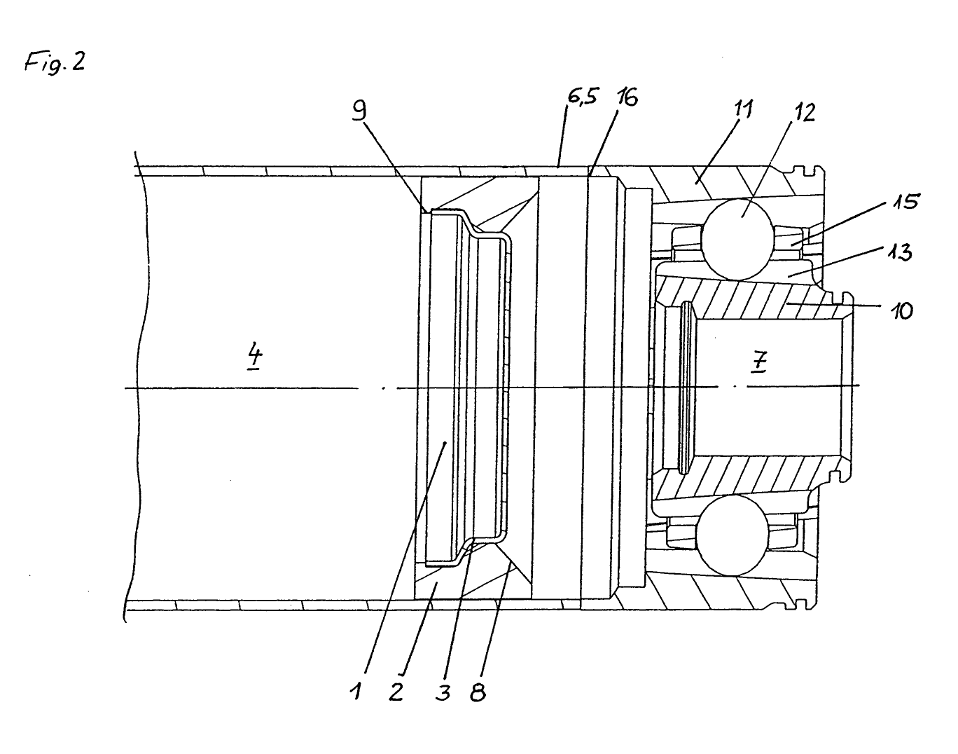

FIG. 2 shows an alternate embodiment of the configuration of the sealing and securing element 1 and of its arrangement in the interior of a longitudinal shaft 4. FIG. 2 shows a homokinetic joint 7, analogous to the homokinetic joint 7 according to FIG. 1, wherein a smooth cylindrical longitudinal shaft 4 is connected by way of weld 16 to the outer joint part 11 without a specially configured center part.

As shown, the sealing and securing element 1, analogous to the first exemplary embodiment, includes molded part 2 into which closure lid 3 is inserted. The molded part 2 possesses an outer circumferential projection 9 on the left side, at which the closure lid 3 comes to rest, and a guide bevel 8 is provided in the direction of the homokinetic joint 7.

The outer circumference of the molded part 2 is adapted in accordance with the continuously cylindrical configuration of the longitudinal shaft 4, and thus is also configured cylindrically over its entire width.

The integration and positioning of the sealing and securing element 1 takes place analogous to what has already been described above, in that the sealing and securing element 1 is inserted by pressing towards the inside diameter of the longitudinal shaft 4, by way of the outer diameter of the molded part 2. This is implemented by means of the elasticity of the material from which the molded part 2 is produced, and by means of the diameter-related dependence of the inside diameter of the longitudinal shaft 4 and the outside diameter of the molded part 2.

The inner structure of the molded part 2 is adapted to the outer shape of the closure lid 3, as also shown in FIG. 1, so that it can be inserted into the molded part 2 with shape fit and force fit. Thus, the two parts of the sealing and securing element possess shape structures having the same coverage.

Accordingly, while only a few embodiments of the present invention have been shown and described, it is obvious that many changes and modifications may be made thereunto without departing from the spirit and scope of the invention.

What is claimed:

1. A sealing and securing element for a homokinetic joint between hollow longitudinal shafts, the sealing and securing element disposed in an interior of the hollow longitudinal shaft in a region of a connection point of the hollow longitudinal shaft to the homokinetic joint, the sealing and securing element comprising:
a) a molded part comprising:
i) an inner structure configured in a first stepped shape and having two accommodation openings;
ii) a guide bevel in a direction of the homokinetic joint; and
iii) a circumferential projection; and
b) a closure lid for sealing an interior of the homokinetic joint relative to the hollow longitudinal shaft, said closure lid comprising an outer structure configured in a second stepped shape and having two projections;
wherein said inner structure of said molded part is adapted to said outer structure of said closure lid and has a same coverage as said outer structure; and
wherein said closure lid is pressed into an interior of said molded part and rests against said circumferential projection.

2. The sealing and securing element according to claim 1, wherein a shape-fit and force-fit connection between said molded part and said closure lid is formed as a result of a pressed-in arrangement of said molded part and said closure lid.

3. The sealing and securing element according to claim 1, wherein said molded part comprises a soft and deformable material.

4. The sealing and securing element according to claim 3, wherein said soft and deformable material comprises an elastomer.

5. The sealing and securing element according to claim 1, wherein said molded part comprises an easily deformable metallic material.

6. The sealing and securing element according to claim 1, wherein an outer shape of said molded part is adapted to an inner shape or configuration of the hollow longitudinal shaft in a region of a connection of the hollow longitudinal shaft to an outer joint part of the homokinetic joint.

7. The sealing and securing element according to claim 6, wherein said outer shape of said molded part is configured to be smooth and cylindrical over an entire width of said molded part.

8. The sealing and securing element according to claim 6, wherein said outer shape of said molded part comprises an outer circumferential collar in the direction of the homokinetic joint.

9. The sealing and securing element according to claim 1, wherein said closure lid is brought into said molded part in such a manner that said closure lid is pressed into said molded part and said circumferential projection allows said closure lid to click into said molded part.
